(19) United States
(12) Patent Application Publication
(10) Pub. No.: US 2015/0134261 A1
(43) Pub. Date: May 14, 2015

(54) SYNCHRONIZATION OF PATIENT MOTION DETECTION EQUIPMENT WITH MEDICAL IMAGING SYSTEMS

(71) Applicants: J. Michael O'Connor, Nashua, NH (US); P. Hendrik Pretorius, Worcester, MA (US); Karen Louise Johnson, Princeton, MA (US); Michael A. King, Northboro, MA (US)

(72) Inventors: J. Michael O'Connor, Nashua, NH (US); P. Hendrik Pretorius, Worcester, MA (US); Karen Louise Johnson, Princeton, MA (US); Michael A. King, Northboro, MA (US)

(21) Appl. No.: 14/080,353

(22) Filed: Nov. 14, 2013

(51) Int. Cl. G06F 19/00; G01T 1/29

(52) U.S. Cl. CPC G06F 19/34; G01T 1/2985
USPC 702/19

(57) ABSTRACT

An improved system and method to acquire physiological information about a state of a subject, such as SPECT and PET information. The system generates a predetermine sequence of pulse signals and combines that sequence with a first physiological signal to generate a time-base signal. The time-base signal is than combined with a second physiological signal. The combined signals are analyzed to determine accurate temporal synchronization of the first and second physiological signals. The system can be generalized to handle more than two physiological signals. Examples of physiological signals can be for example EKG signals, tomography signals, gross-body motion signals, respiratory motion signals, voluntary motion signals, involuntary motion signals and other signals. The analyzed data can be displayed and/or recorded, and provides physiological information about a state of the subject.

### STATEMENT REGARDING FEDERALLY FUNDED RESEARCH OR DEVELOPMENT

This invention was made with government support under Grant No. R01-EB01457 awarded by National Institutes of Health. The government has certain rights in the invention.

### FIELD OF THE INVENTION

The invention relates to signal acquisition in general and particularly to signal acquisition of multiple data streams using a single input channel.

### BACKGROUND OF THE INVENTION

The inventors and their colleagues have had a long record of investigation on correcting patient motion during some imaging modalities. In general the longer the acquisition time, the greater the benefit for motion correction. One of the methods examined in the past is utilizing motion tracking equipment that enable infrared cameras to track retro-reflective markers placed on the patient. One of the fundamental requirements is to be able to synchronize the motion tracking equipment with any imaging acquisition sequence. In general one would like to synchronize motion capture data with acquisition timing within one millisecond. Prior art does provide some methods for the synchronization. A current problem with synchronization is that manufacturers of medical imaging systems typically allow only input of one physiological signal which is normally employed for Electrocardiography (ECG).

There is a need for improved systems and methods for acquiring usable physiological signals with compensation for body and respiratory motion using a single data channel.

### SUMMARY OF THE INVENTION

According to one aspect, the invention features a system of synchronization of two physiological measurements. The system comprises a first physiological sensor configured to measure a first physiological measurement as a function of time from a subject and to provide a first electrical signal that encodes data representative of the first physiological measurement, the first physiological sensor having a first physiological sensor output terminal at which the first electrical signal is provided; a second physiological sensor configured to measure a second physiological measurement as a function of time from the subject and to provide a second electrical signal that encodes data representative of the second physiological measurement, the second physiological sensor having a second physiological sensor output terminal at which the second electrical signal is provided; at least one of the first physiological sensor and the second physiological sensor having a respective input terminal configured to receive a time base signal; a pulse sequence generator configured to generate a pulse sequence signal having a predetermined number N equal to or greater than 3 of pulses spaced apart in a predetermined temporal sequence, the pulse sequence generator having a pulse sequence generator input terminal configured to receive a start command, the pulse sequence generator having a pulse sequence generator output terminal at which the pulse sequence signal is provided; an input channel combiner having two input channel combiner input terminals configured to receive a respective first input electrical signal and a second input electrical signal, a respective input terminal of the two input channel combiner input terminals connected to the pulse sequence generator output terminal and the other of the two input channel combiner input terminals connected to a selected one of the first physiological sensor output terminal and the second physiological sensor output terminal, the input channel combiner configured to combine the first input electrical signal and the second input electrical signal according to the logic represented by Table I for active-low logic or Table II for active-high logic, the input channel combiner having one input channel combiner output terminal configured to provide a time base signal as an output signal to the input terminal of the other of the first physiological sensor and the second physiological sensor; and a signal analyzer configured to receive an electrical signal for analysis from the output terminal of the other of the first physiological sensor and the second physiological sensor, the electrical signal for analysis comprising a combination of the first electrical signal, the second electrical signal and the pulse sequence signal.

In one embodiment, the pulse sequence generator is configured to generate a pulse sequence signal having a predetermined initial delay from a start command.

In another embodiment, the signal analyzer is configured to analyze the synchronism of the first and the second so long as the signal analyzer can resolve at least two pulses of the pulse sequence.

In yet another embodiment, the pulse sequence generator configured to generate the pulse sequence at any time that the first electrical signal or the second electrical signal are present.

According to another aspect, the invention relates to a method of synchronization of two physiological measurements. The method comprises the steps of measuring a first physiological measurement as a function of time from a subject and providing a first electrical signal that encodes data representative of the first physiological measurement; generating a pulse sequence signal having a predetermined number N equal to or greater than 3 of pulses spaced apart in a predetermined temporal sequence; combining the first electrical signal and the pulse sequence signal according to the logic represented by Table I for active-low logic or Table II for active-high logic to provide a time base signal; measuring a second physiological measurement as a function of time from the subject and providing a second electrical signal that encodes data representative of the second physiological measurement; combining the time base signal with the second electrical signal; and analyzing the combination of the time base signal and the second electrical signal to determine a result representing a temporal relationship between the first physiological measurement and the second physiological measurement.

In one embodiment, the method further comprises the step of performing at least one of recording the result, transmitting the result to a data handling system, or to displaying the result to a user.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is an image of an input channel combiner (ICC), cardiac trigger monitor (CTM), and a side of a BrightView XCT (BVXCT) imaging bed with channel input BNC connector. The visual tracking system (VTS) is outside the image shown.

FIG. 1B is a close-up image of the ICC with input coaxial BNCs and the output coaxial BNC. The ICC performs a logical AND of two “active low” TTL signals (see the schematic AND-gate in the inset at the upper right).

FIG. 2A is a graph of the input VTS start pulse sequence.

FIG. 2B is a graph of the ECG R-wave pulse.

FIG. 2C is a graph showing the output to the BVXCT.

FIG. 3A is a graph of the input VTS start pulse sequence.

FIG. 3B is a graph of the ECG R-wave signal.

FIG. 3C is a graph showing the output to the BVXCT.

FIG. 4 is a flowchart showing a procedure for synchronizing a first physiological signal with a second physiological signal. Alternatively, FIG. 4 may be understood as showing elements of a system that provides a first physiological signal synchronized with a second physiological signal.

### DETAILED DESCRIPTION

Purpose:

We describe a method for combining a signal to synchronize a patient-monitoring device that provides a first physiological signal with a second physiological signal generated by a second patient-monitoring device for inclusion into list-mode acquisition. One embodiment is an application that requires synchronizing an external patient motion-tracking system with a medical imaging system by multiplexing the tracking input with the ECG input. It is believed that the methodology described can be adapted for use in a variety of medical imaging modalities including single photon emission computed tomography (SPECT) and positron emission tomography (PET).

Methods:

We insert a unique pulse sequence into a single physiological input channel. This sequence is then recorded in the list-mode acquisition along with the R-wave pulse used for ECG gating. The specific form of the inserted pulse sequence allows for recognition of the time point being synchronized even when portions of the pulse sequence are lost due to collisions with R-wave pulses. This was achieved by altering the software used in binning the list-mode data to recognize even a portion of the inserted pulse sequence. Limitations on heart rates at which the inserted pulse sequence could be reliably detected were investigated by simulating the mixing of the two signals as a function of heart rate and time point during the cardiac cycle at which the inserted pulse sequence is mixed with the cardiac signal. In particular, the unique pulse sequence includes a plurality of pulses, each pulse having a predetermined duration and each pulse after the first being delayed from its predecessor by a unique delay period. The pulse sequence is constructed so that as long as two pulses can be distinguished, the delay between the earlier distinguished pulse and the later distinguished pulse uniquely determines which of the pulses in the sequence are being distinguished. By knowing which pulses are distinguished, and knowing the delay between those two pulses, one effectively provides a “temporal ruler” for measuring the temporal position of any feature in any of the physiological signals. One thereby can analyze the temporal relations between the physiological signals (or equivalently, how they are synchronized at specific times). If more than two pulses can be distinguished, the timing data is over-determined. It is believed that this approach can be used to determine the synchronization among more than two physiological signals as well given that different signals would have different unique pulse sequences.

Results:

We have successfully achieved accurate temporal synchronization of a motion-tracking system with acquisition of SPECT projections used in 17 recent clinical research cases. In simulation analysis it has been determined that synchronization to enable compensation for body and respiratory motion could be achieved for heart rates up to 125 beats-per-minute (bpm).

Conclusions:

Synchronization of list-mode acquisition with external patient monitoring devices such as those employed in motion-tracking can reliably be achieved using a simple method that can be implemented using minimal external hardware and software modification through a single input channel, while still recording cardiac gating signals.

We describe a solution to the multiplexing of the ECG plus other signals so that synchronization with other sources of input can also occur through this one input channel.

The invention encodes a short pulse sequence precisely triggered by the start of data capture for patient motion tracking into an imaging system input stream that is designed to receive a signal output by an Electrocardiography (ECG) monitor. The ECG monitor output signal is triggered by each “R-Wave” in a ECG. The ECG monitor signal (implemented as a TTL signal) is normally input into a BNC input connector in the imaging system. The invention alters this typical configuration by routing the ECG monitor signal into an electronic device of our design. Into this device we also receive the output of motion tracking signal (also implemented as a TTL level signal). Our device performs a logical AND of the two signals and outputs one signal into the aforementioned BNC input connector in the imaging system.

It is believed that the distinct aspects of this invention that differentiate it from prior art are:
1. Use of one input channel which is recorded in the list-mode data stream to capture two or more distinct and fundamentally asynchronous data streams (ECG R-wave timing and the start of motion capture data sequence). The input channel is normally used only for one physiological signal such as ECG timing.
2. Use of a short pulse sequence for the additional data streams. The sequence can be as short as four pulses and is intended not to be ongoing so as not to interfere with the subsequent ECG timing. In one described implementation we inject the short pulse sequence before the start of a study's use of the ECG timing. However, it is believed that the pulse sequence could be also be injected afterwards with equal success.
3. Variation of each pulse in the pulse interval so that in the event of collision of the two asynchronous signals that synchronization can still be determined. We have shown in the described implementation that even in “collision cases” (i.e., simultaneous arrival of an ECG mark with one of the pulses in the short pulse sequence) synchronization can be determined
4. Processing methodology and software implementation that can determine synchronization (i.e. discriminate the two signals multiplexed onto the one channel).
   Deficiencies or Limitations Overcome by this Invention

Generically, various imaging systems allow inputs from other devices in what are sometimes termed “physiological signals.” An ECG signal would be an example of such a signal. Some (but not all) provide multiple inputs. Some vendors implement special constraints on utilizing second channels (while ECG monitor input would almost always be a standard input). The invention accommodates systems with only one physiological input or systems with restricted secondary inputs. Additionally, the invention eases processing of the input stream so that once the short pulse sequence is determined, the subsequent input will only be ECG timing marks. This simplifies the processing of timing signals.

During the course of emission imaging, patients undergo both physiological motion¹ and gross body-motion.^{2, 3} These can result in reduced image quality and artifacts that can impact diagnostic accuracy. A number of researchers have developed list-mode based correction techniques. Examples include correction methods for patient respiration motion in single photon emission computed tomography (SPECT) (Refs. 4-8) and other forms of patient motion during SPECT.⁹⁻¹² List-mode correction techniques have also been reported for both animal motion in preclinical positron emission tomography (PET) (Ref 13) and patient head motion in neuro-PET.¹⁴ Additionally, in some imaging protocols the input of the ECG R-wave pulses allow acquisitions to be gated in order to capture heart motion to better assess cardiac function.¹⁵ In all of those various methods that incorporate motion tracking and/or ECG gating there is a basic need to synchronize external gating/tracking systems with the imaging system. In our SPECT research we often incorporate cardiac gating along with corrections for both respiratory and gross body motion. We have utilized a visual tracking system (VTS) for estimating signals related to both respiratory and gross body motion through stereo-imaging of retro-reflective markers mounted on stretchy bands wrapped about the patient's chest and abdomen.16-20 Our correction methods for both respiratory and body motion have been previously reported.21-23 To capture external events from several asynchronous sources some imaging vendors provide several physiological input channels. Other vendors may only provide a single physiological channel thereby complicating the insertion of inputs from two or more sources. Such is our case in which we can only easily access one physiological input channel to input both our cardiac gating signal and our motion tracking timing signal. In the past this has prevented us from performing respiratory and body motion corrections along with ECG gated acquisitions.

A solution to our problem, which we have formulated, implemented, and tested in clinical acquisitions is the subject of this disclosure. We believe the system and method is novel in that a short duration pulse sequence for our synchronization timing mark is used. This sequence is designed to tolerate a potential “collision” of the individual pulses in the sequence with the asynchronous R-wave output whose input channel to list-mode acquisition it shares. This approach can be modified to work for other applications; thus the method might be useful for other research groups that might need to input several signals onto one physiological channel.

### Methods

### Description of the Problem

We developed a VTS that can be used to correct patient respiratory and body motion in SPECT myocardial perfusion imaging (MPI).16-20 Our approach consists of near-infrared MX motion capture cameras, a MX Ultranet hardware controller, and software running on a Windows workstation purchased from Vicon Motion Systems Ltd., Oxford, UK. We use the VTS to track multiple retroreflective markers placed on a patient's chest and abdomen at a marker-tracking rate of 30 Hz. Motion tracking by this system needs to be temporally synchronized with the list-mode acquisition of SPECT studies acquired by our BrightView XCT Imaging SPECT/CT System (Philips Healthcare, Cleveland, Ohio). In the past we have performed motion tracking solely in the absence of cardiac gating. We decided to find a way to input into the BrightView XCT (BVXCT) both the ECG signal and a pulse sequence generated by the MX Ultranet controller marking the start of VTS acquisition. With a start signal recorded in the list-mode file of the BVXCT, one-millisecond VTS temporal synchronization accuracy can be established. Our problem was how to achieve this synchronization while also acquiring the ECG through only one physiological input channel.

### Novel Second Input Signal

Utilizing a second signal to indicate the VTS-start we are confronted with one fundamental implementation problem. The issue is that the two signals sharing the single input channel are asynchronous. Our solution must handle the case in which any VTS signal arrives during the window in which an ECG R-wave signal is already asserted (i.e., 150 ms pulse length). This will result in an obscured VTS signal. We refer to this condition as a “collision case” and the window as a “collision window.” There are also timing cases that, while not obscuring the VTS signal, might confound interpretation of the cardiac gating for one cardiac interval. These cases would obscure the arrival of the ECG R-wave during the window in which any VTS signal is already asserted (i.e., 50 ms pulse length). The special case of the simultaneous arrival of both an ECG R-wave and a VTS signal may or may not confound interpretation depending on the list-mode processing implementation but again at worst should only confound one gating interval. Confounding one interval of cardiac gating is not an issue in our imaging protocol but might need to be considered in other applications of this method as will be explained further.

Our basic approach for injecting the start of VTS signal is to use a short pulse sequence that can be inserted into the physiological channel such that it will be interpreted by the BVXCT as an ECG R-wave. Post-processing will then detect these pseudo-R-wave events in the list-mode file to determine if it is a start mark. Our initial concept was to use a reduced pulse interval. This interval needed to have a sufficient duration such that it would be detected as an ECG pulse (i.e., it does not result in an imaging system ECG alarm). We empirically determined that a continuous stream of 50 ms active-low TTL pulses with a pulse rate greater than 115 ms would not trigger a BVXCT cardiac alarm. Based on this finding we decided to use pulse width of 50 ms and a pulse interval of 125 ms or greater. We verified that synthesized active-low TTL pulse streams with those limits would be entered as individual R-wave events in a list-mode file without triggering an alarm. The shorter pulse width is useful for distinguishing pulses on an oscilloscope trace but is not absolutely necessary for our implementation. Having separate pulse widths in order to encode information is known as pulse-width modulation (PWM). PWM might be useful if imaging system vendors were to enhance the capability of a single physiological channel, as we discuss herein below.

Having determined our basic pulse timing, we then focused on the aforementioned design goal of tolerating “collision window” cases. We believe that patients would not undergo cardiac stress imaging if they were presenting with heart rates much greater than 110 bpm (a R-wave on average of once every 545 ms) so our design goal was that our short pulse sequence should be able to tolerate a collision for a patient with a rapid heart rate up to 120 bpm (i.e., heartbeat once every 500 ms). We realized that if the interval between pulses were different yet known that we could accurately determine the arrival time of the VTS start. To accomplish start detection we believe that accurate interval timing between two consecutive pulses in the four-pulse sequence is needed (i.e., one known pulse interval would survive any “collision”). For a four-pulse sequence we then selected three different pulse intervals following the first pulse. We experimented with different pulse widths and then somewhat arbitrarily selected intervals of 125, 150, and 175 ms. To summarize our current sequence specification: (1) four active-low TTL pulses, (2) each pulse is 50 ms wide, (3) the first pulse occurs at 25 s after VTS start, (4) the second pulse is 175 ms after the start of the first pulse, (5) the third pulse is 150 ms after the start of the second pulse, and (6) the final pulse is 125 ms following the start of the third pulse.

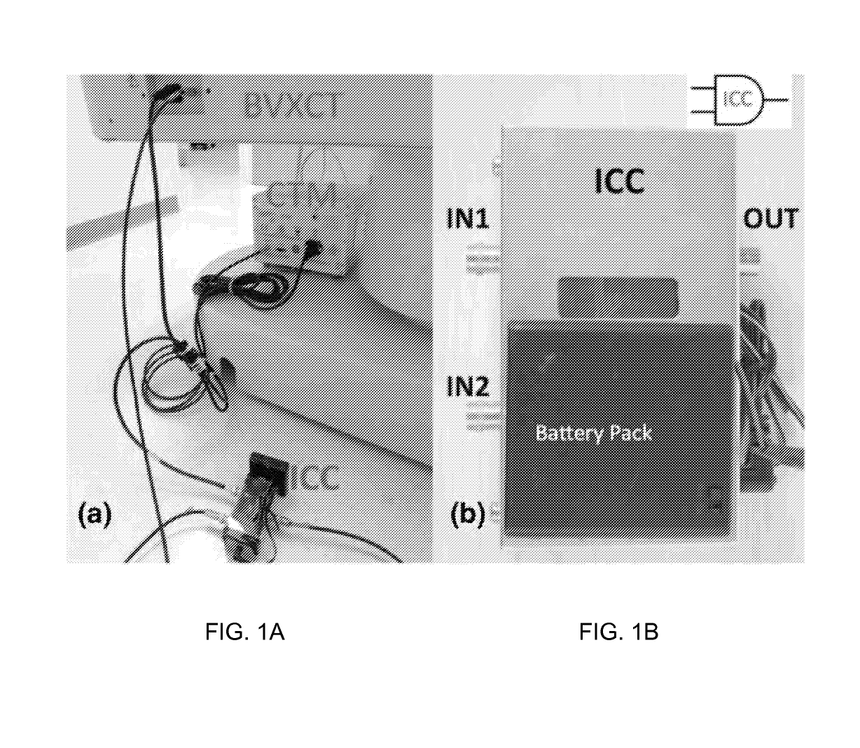

Our method alters the typical clinical system interface configuration by routing the cardiac trigger monitor (CTM) (Ivy Biomedical Systems Inc., Branford, Conn.) coaxial output into a simple electronic device of our design instead of directly into the BVXCT. We refer to our device as an input channel combiner (ICC). Into this ICC we also route a second TTL input, which carries the just described four-pulse start sequence generated 25 s after VTS start. Simply, the ICC performs a logical OR of the two TTL input signals and outputs a combined TTL signal into the aforementioned BVXCT BNC input connector. This operation can be implemented by a TTL AND of the two signals when using TTL active-low logic as shown in FIG. 1A and FIG. 1B. Alternatively, the operation could be implemented by a TTL OR of the two signals when using TTL active-high logic. The choice of active-low or active-high is determined by output specifications of the two input signals and is largely an implementation choice. For the purpose of this disclosure our explanation is based on active-low logic but it is well know that TTL logic operations can be implemented with either active-low or active-high by merely interchanging the applicable positive gate logic.

The “truth” or state table for the ICC using TTL active-low logic is displayed in Table I. Essentially this table illustrates that the BVXCT input would be asserted (active-low) whenever either ICC input is low.

TABLE I
ICC ‘truth’ or state table for a
LOGICAL OR using active-low logic

| VTS out (ICC in 1) | CTM out (ICC in 2) | BVXCT in (ICC out) |
|---|---|---|
| H | H | H |
| xx | L | L |
| L | xx | L |

Table I: H = High or ~5 V (not asserted), L = Low or ~0 V (asserted), xx = either H or L (i.e. so-called “don't care”) for TTL active-low logic.

Equivalently the state table if one were to use active-high logic is shown in Table II. This logic would assert (active-high) whenever either ICC input is high.

TABLE II
ICC ‘truth’ or state table for a
LOGICAL OR using active-high logic

| VTS out (ICC in 1) | CTM out (ICC in 2) | BVXCT in (ICC out) |
|---|---|---|
| L | L | L |
| xx | H | H |
| H | xx | H |

Table II: H = High or ~5 V (asserted), L = Low or ~0 V (not asserted), xx = either H or L (i.e. so-called “don't care”) for TTL active-high logic.

While the present description uses an input channel combiner having two input channels, it should be understood by those of ordinary skill in the art that one can equally well provide an input channel combiner having more than two inputs, and that the systems and methods described herein can be generalized to studying the temporal relations or synchrony between two signals or among more than two signals. One simple way to provide a third input is to cascade two ICCs each having two inputs, so that the output of the first ICC is a combined signal that is fed as input to one of the second ICC inputs and another (third) signal is provided at the other input of the second ICC. In such an instance, there may be a delay by the time that is required for the first ICC to combine the first and second input signals (which will be an extremely short delay of the order of micro- or nano-seconds, which in physiological terms is trivial). Another implementation is to provide an N input OR gate, where N is an integer greater than or equal to the number of signals to be combined, and in the case where N exceeds the number of signals to be combined, to hold the excess inputs at a signal level that causes them to be inactive (for example by using “pull-up” or “pull-down” resistors, as may be convenient).

We add that to generate the four-pulse sequence we take advantage of the capability of the VTS to generate up to four separate single-pulses according to user configurable parameters. This allows us to generate the aforementioned pulse timing. It was necessary for us to combine these separate pulses in an external device that is conceptually similar to the described ICC but implements an active-low TTL quad-AND of the individual pulses to produce the combined pulse sequence.

FIG. 1A is an image of an input channel combiner (ICC), cardiac trigger monitor (CTM), and a side of a BrightView XCT (BVXCT) imaging bed with channel input BNC connector. The VTS is outside the image shown.

FIG. 1B is a close-up image of the ICC with input coaxial BNCs and the output coaxial BNC. The ICC performs a logical AND of two “active low” TTL signals (see the schematic AND-gate in the inset at the upper right).

### Post-Processing of List-Mode File

Following acquisition, output files from the VTS and list-mode are processed using software from various sources combined into one comprehensive software package written in C. The first subroutine is a significantly modified version of software purchased from Philips Healthcare (Cleveland, Ohio) to bin the list-mode data into projection data for conventional reconstruction. Within the list-mode data stream there is an event (or in some intervals multiple events) recorded every millisecond. During this rebinning process, all the ECG R-Wave pulses recorded in the list are detected and stored in a timing file. After all list-mode events have been processed and separated into files according to category (timing, control, and photon events) subsequent processing occurs. By then the photon events have been collected in 100 ms increments for each projection. The timing file can be processed for both gating marks and the unique pulse sequence (i.e., recorded as “pseudo-R-wave” events). At this point a synchronization file is generated for use by a second subroutine that aligns the SPECT data with the VTS motion data recorded at a rate of 30 Hz in a comma-separated values (csv) text file. After file processing the data streams are synchronized and can then be used for subsequent motion estimation and compensation prior to and during reconstruction, respectively.

### Pulse Sequence Simulation

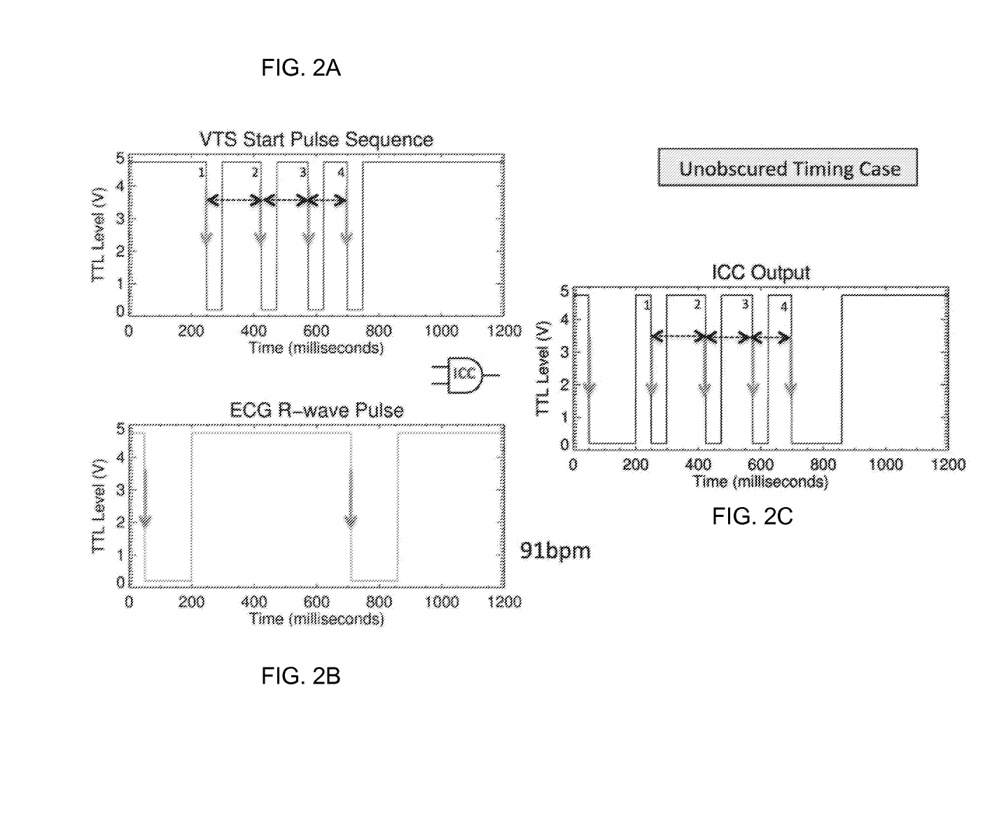

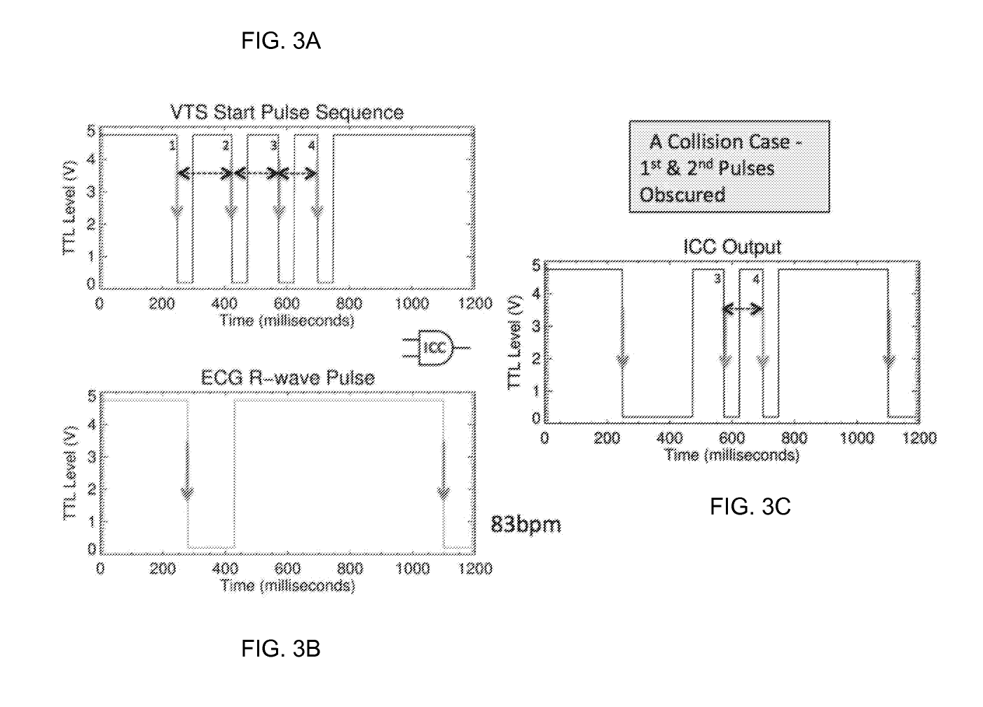

We validated our four-pulse sequence design through simulation. We wrote a simple simulation program using IDL (Exelis Visual Information Solutions, Inc., Boulder, Colo.). A copy of the program code is provided in an appendix. The program simulates two signals: a repetitive CTM output trigger pulse for a specified heart rate; the specified four-pulse sequence previously described. The two signals are logically combined consistent with a TTL AND-gate. The output is then analyzed to ensure that VTS start can be detected. For each case the two signals are combined at every possible interval (at one-millisecond resolution) thereby simulating various timing interactions. These variations would include all possible collision and non-collision cases for the specified heart rate. Any simulated interaction in which the VTS start cannot be detected is reported. We illustrate a non-obscured timing case in FIG. 2A. FIG. 2B and FIG. 2C and a “collision case” in which VTS start timing can still be recovered in FIG. 3A, FIG. 3B and FIG. 3C.

### Clinical Application of the Method

Under IRB approval 24 and with patient consent, all of our research acquisitions are obtained during the stress portion of physician-ordered clinical SPECT MPI Immediately following the clinical stress imaging a second non-gated research study is performed and the patient is asked to move. Both acquisitions require VTS and SPECT synchronization for accurate motion and respiratory correction. For our method a research acquisition requires three additional steps beyond typical clinical SPECT MPI acquisition:
1. Placement of the retro-reflective markers on the patient's chest and abdomen.
2. Use of list-mode acquisition.
3. The addition of the aforementioned ICC device and reconfiguration of coaxial inputs.

The VTS is started shortly after the start of the imaging protocol. The VTS pulse pattern starts precisely 25 s after VTS start. This start interval can be adjusted but for our research this initial 25 s delay period was selected so that the start pattern would occur prior to actual emission imaging (i.e., during bed positioning). Our system list-mode acquisition includes the recording of timing marks, camera, and bed motion, etc., which occur prior to the start of recording emission events. This makes the insertion of our pattern possible without conflicting with R-wave trigger marks. Other systems that start list-mode recording only upon start of emission events there is the likelihood of a conflict that might corrupt one cardiac event. We speculate that for those systems there is a possibility that the start pattern described herein would result in a shortened R-wave interval that would then be rejected by the window employed for acceptance. This would mean that those emissions for that one interval would not contribute to imaging. Over an entire imaging study this one lost interval might be acceptable.

FIG. 2A, FIG. 2B and FIG. 2C illustrate a case in which the VTS start pulse is not obscured despite the proximate arrival of the R-wave signal with the fourth VTS start pulse.

FIG. 2A is a graph of the input VTS start pulse sequence.

FIG. 2B is a graph of the ECG R-wave pulse.

FIG. 2C is a graph showing the output to the BVXCT. In this case all four start pulses would be recognized because pulse-width 1-2 (175 ms), pulse-width 2-3 (150 ms), and pulse-width 3-4 (125 ms) are known and occur within the expected window. The ECG R-wave pulse arrives 9 ms after last start pulse and therefore would not obscure the fourth VTS timing mark.

FIG. 3A, FIG. 3B and FIG. 3C illustrate the case of “collision” between R-wave signal and VTS start pulse.

FIG. 3A is a graph of the input VTS start pulse sequence.

FIG. 3B is a graph of the ECG R-wave signal.

FIG. 3C is a graph showing the output to the BVXCT. In this case pulses 3 and 4 would be received and pulse-width 3-4 (125 ms) is known and occurs within the expected window. Start would be detected even though pulse width 1-2 and pulse width 2-3 were obscured by the R-wave signal.

### Results

We verified basic system list-mode timing accuracy of one millisecond by examining if there were any variations in list-mode determined timing from a known external timing source (the CTM). The imaging system provides a list-mode event every millisecond. The CTM can output a simulated heart rate. We setup test studies with CTM configured for various heart rates (40, 60, 90, and 120 bpm). In all of those studies the standard deviation for heart rate was 0 ms. Simulation results confirmed that with a R-wave interval greater than 475 ms (i.e., heart rate less than 126 bpm) one of the known VTS start pulse intervals would always be detected for any of the possible collision arrival times throughout a 450 ms pulse sequence window (i.e., from start of first pulse to start of fourth pulse). The simulation program examines 610 cases for any given ECG interval. The number of timing cases cover an overlap window from 155 ms prior to the first pulse in the sequence through 5 ms following the fourth pulse in the sequence in one millisecond steps (i.e., 610 ms overlap period). Each output case from the combination of the two asynchronous signals is determined as a variable ECG window is slid in one millisecond steps over the entire 450 ms pulse sequence window. This simulated overlap period will cover all of the possible collision cases. The simulation results show that for any ECG interval of 476 ms or greater that at least one VTS start interval can be reliably detected by the analysis software.

Since February 2013 we have incorporated our synchronization method into our research protocol. From that time we have successfully synchronized data streams for 17 clinical research cases. For these cases the research patients' heart rates ranged from 66 to 100 bpm. A majority of these cases involved a collision window obscuring at least one of the four pulses as will be explained. Keeping in mind the simulation example illustrated in FIG. 3 in which only one of the known pulse intervals (the 125 ms or 3rd interval between pulse 3 and 4) was recovered, we examined the pulse intervals for all 17 clinical cases. All three pulse intervals were captured in five of the cases (i.e., no “collision”). In nine of the collision cases two intervals were detected (interval 1 and 2 in seven cases; interval 2 and 3 in two cases). In three collision cases only one pulse interval was recorded (interval 2 in one case and interval 3 in two cases). The results of these 12 collision cases in the 17 clinical cases reinforce the simulation results that for typical clinical heart rates, synchronization can be determined.

We are aware of a previous method for the synchronization of respiratory motion data with list-mode data.25 However, we believe that our implementation is novel because it allows the input channel to be shared and it handles the so-called “collision window” cases.

While some medical imaging systems do provide additional physiological channels, we believe there may be instances in which there may be a need to combine asynchronous signals on a single physiological channel. In such instances we believe our method could be a useful improvement.

Additionally, our method eases post-processing of two input data streams because only one short four-pulse sequence must be processed; thereafter all subsequent list-mode input data streams because only one short four-pulse sequence must be processed; thereafter all subsequent list-mode input would only be ECG timing events. This simplifies the post-processing of timing signals.

In our specific implementation we discovered without vendor assistance that pulse-widths less than 150 ms, as configured by the vendor for ECG R-wave detection in clinical use, would also be interpreted as R-wave events. As we have discussed, in our implementation we determined that 50 ms active-low TTL pulses were equivalent to 150 ms pulses. This permits us to speculate that it might be possible for us to reduce both the CTM pulse-width as well as the VTS start sequence pulse-widths. This would reduce but not eliminate the overlap of any simultaneous active-low TTL signals thereby somewhat reducing the collision window and possibly allow support for higher heart rates. We intend to discuss this with our vendor and so may modify our pulse timing in the future.

We suggest that it would also be possible for vendors of medical imaging system to use pulse-width modulation (PWM) and thus enable their channel input processing to differentiate between different pulse widths in a single channel. By differentiating among list-mode events based on pulse widths, post-processing would not be needed to discriminate events. We speculate that it might be possible to extend this concept to more than two event classes. Ideally, if there were a standard among vendors for encoding interface pulse sequences, methods for combining channel input could be even more widely shared.

We now state a few caveats. No timing drift analysis of VTS and our SPECT system between synchronization at the start and the end of SPECT acquisition was performed in our work. Our results are based on list-mode processing for one system (BVXCT) and one motion tracking system (Vicon). While we hope that our method may be useful to others, list-mode implementations by other vendors and integration with other motion tracking systems might produce different results.

Patient motion is inevitable during several imaging modalities. Patient motion is known to degrade diagnostic accuracy. Our overall research goal is to develop and improve methods for motion tracking and correcting patient motion when it occurs. One of our recent method improvements that we have just described involved the synchronization of our VTS with our acquisition list-mode events using a shared BVXCT input channel.

We have shown in our current implementation and early usage that even in collision cases synchronization can be determined. While we have only achieved results using our specific devices, we believe this method could be adapted to work reliably in other systems.

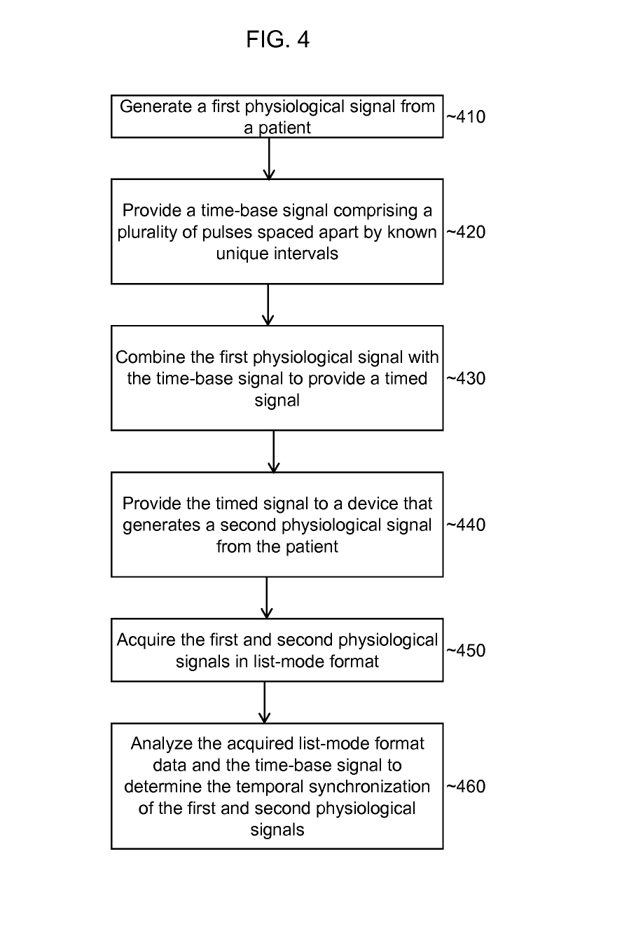

FIG. 4 is a flowchart showing a procedure for synchronizing a first physiological signal with a second physiological signal. Alternatively, FIG. 4 may be understood as showing elements of a system that provides a first physiological signal synchronized with a second physiological signal.

As shown in FIG. 4, at step 410 one generates a first physiological signal from a patient. At step 420 one provide a time-base signal comprising a plurality of pulses spaced apart by known unique intervals. At step 430 one combines the first physiological signal with the time-base signal to provide a timed signal. At step 440 one provide the timed signal to a device that generates a second physiological signal from the patient. At step 450 one acquires the first and second physiological signals in list-mode format. At step 460 one analyzes the acquired list-mode format data and the time-base signal to determine the temporal synchronization of the first and second physiological signals.

### REFERENCES

1. M. M. Ter-Pogossian, S. R. Bergmann, R. Steven and B. E. Sobel, “Influence of cardiac and respiratory motion on tomographic reconstructions of the heart: Implications for quantitative nuclear cardiology,” J. Comput. Assist. Tomogr. 6(6), 1148-1155 (1982).
2. E. H. Botvinick et al., “A quantitative assessment of patient motion and its effect on myocardial perfusion SPECT images,” J. Nucl. Med. 34(2), 303-310 (1993).
3. J. A. Cooper, P. H. Neumann, and B. K. McCandless, “Effect of patient motion on tomographic myocardial perfusion imaging,” J. Nucl. Med. 33(8), 1566-1571 (1992).
4. L. Livieratos et al., “Rigid-body transformation of list-mode projection data for respiratory motion correction in cardiac PET,” Phys. Med. Biol. 50(14), 3313-3322 (2005).
5. G. Kovalski et al., “Correction of heart motion due to respiration in clinical myocardial perfusion SPECT scans using respiratory gating,” J. Nucl. Med. 48(4), 630-636 (2007).
6. F. Lamare et al., “List-mode-based reconstruction for respiratory motion correction in PET using non-rigid body transformations,” Phys. Med. Biol. 52(17), 5187-5204 (2007).
7. P. P. Bruyant et al., “Compensation of respiratory motion in cardiac SPECT with list-mode acquisition and an external respiration-tracking device,” J. Nucl. Cardiol. 11(4), S34 (2004).
8. J. Dey et al., “Estimation and correction of cardiac respiratory motion in SPECT in the presence of limited-angle effects due to irregular respiration,” Med. Phys. 37(12), 6453-6465 (2010).
9. B. Feng et al., “Estimation of the rigid-body motion from three-dimensional images using a generalized center-of-mass points approach,” IEEE Trans. Nucl. Sci. 53(5, Part 1), 2712-2718 (2006).
10. B. Feng et al., “Use of the three-dimensional Gaussian interpolation in the projector/backprojector pair of iterative reconstruction for compensation of known rigid-body motion in SPECT,” IEEE Trans. Med. Imaging 25(7), 838-844 (2006).
11. S. Gu et al., “Body deformation correction for SPECT imaging,” IEEE Trans. Nucl. Sci. 57(1, Part 1), 214-224 (2010).
12. H. Schumacher, J. Modersitzki, and B. Fischer, “Combined reconstruction and motion correction in SPECT imaging,” IEEE Trans. Nucl. Sci. 56(5, Part 1), 73-80 (2009).
13. A. Z. Kyme et al., “Optimised motion tracking for positron emission tomography studies of brain function in awake rats,” PLoS ONE 6(7), e21727 (2011).
14. P. M. Bloomfield et al., “The design and implementation of a motion correction scheme for neurological PET,” Phys. Med. Biol. 48(8), 959-978 (2003).
15. D. L. Bailey and A. Kalemis, “Externally triggered gating of nuclear medicine acquisitions: A useful method for partioning data,” Phys. Med. Biol. 50, N55-N62 (2005).
16. R. D. Beach et al., “Feasibility of stereo-infrared tracking to monitor patient motion during cardiac SPECT imaging,” IEEE Trans. Nucl. Sci. 51(5, Part 2), 2693-2698 (2004).
17. P. P. Bruyant et al., “A robust visual tracking system for motion detection in SPECT: Hardware solutions,” IEEE Trans. Nucl. Sci. 52(5, Part 1), 1288-1294 (2005).
18. R. D. Beach et al., “An adaptive approach to decomposing patient-motion tracking data acquired during cardiac SPECT imaging,” IEEE Trans. Nucl. Sci. 54(1, Part 1), 130-137 (2007).
19. J. E. McNamara et al., “An assessment of a low-cost visual tracking system (VTS) to detect and compensate for patient motion during SPECT,” IEEE Trans. Nucl. Sci. 55(3, Part 1), 992-998 (2008).
20. J. E. McNamara et al., “A flexible multi-camera visual-tracking system for detecting and correctingmotion-induced artifacts in cardiac SPECT slices,” Med. Phys. 36(5), 1913-1923 (2009).
21. J. Dey and M. A. King, “Theoretical and numerical study of an MLEM and OSEM reconstruction algorithms for motion correction in emission tomography,” IEEE Trans. Nucl. Sci. 56(5, Part 1), 2739-2749 (2009).
22. J. Mitra Mukherjee et al., “Estimation of rigid-body and respiratory motion of the heart from marker-tracking data for SPECT motion correction,” IEEE Trans. Nucl. Sci. 56(1, Part 1), 147-155 (2009).
23. J. Mitra Mukherjee et al., “Quantitative study of rigid-body and respiratory motion of patients undergoing stress and rest cardiac SPECT imaging,” IEEE Trans. Nucl. Sci. 57(3, Part 1), 1105-1115 (2010).
24. UMMS, IRB Docket No. H-10943, Institutional Review Board (IRB), University of Massachusetts Medical School, _.
25. P. P. Bruyant et al., “A method for synchronizing an external respiratory signal with a list-mode PET acquisition,” Med. Phys. 34(11), 4472-4475 (2007).

### DEFINITIONS

Unless otherwise explicitly recited herein, any reference to an electronic signal or an electromagnetic signal (or their equivalents) is to be understood as referring to a non-transitory or a non-volatile electronic signal or a non-transitory or a non-volatile electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux.

Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A system of synchronization of two physiological measurements, comprising:
a first physiological sensor configured to measure a first physiological measurement as a function of time from a subject and to provide a first electrical signal that encodes data representative of said first physiological measurement, said first physiological sensor having a first physiological sensor output terminal at which said first electrical signal is provided;
a second physiological sensor configured to measure a second physiological measurement as a function of time from said subject and to provide a second electrical signal that encodes data representative of said second physiological measurement, said second physiological sensor having a second physiological sensor output terminal at which said second electrical signal is provided;
at least one of said first physiological sensor and said second physiological sensor having a respective input terminal configured to receive a time base signal;
a pulse sequence generator configured to generate a pulse sequence signal having a predetermined number N equal to or greater than 3 of pulses spaced apart in a predetermined temporal sequence, said pulse sequence generator having a pulse sequence generator input terminal configured to receive a start command, said pulse sequence generator having a pulse sequence generator output terminal at which said pulse sequence signal is provided;
an input channel combiner having two input channel combiner input terminals configured to receive a respective first input electrical signal and a second input electrical signal, a respective input terminal of said two input channel combiner input terminals connected to said pulse sequence generator output terminal and the other of said two input channel combiner input terminals connected to a selected one of said first physiological sensor output terminal and said second physiological sensor output terminal, said input channel combiner configured to combine said first input electrical signal and said second input electrical signal according to the logic represented by Table I for active-low logic or Table II for active-high logic, said input channel combiner having one input channel combiner output terminal configured to provide a time base signal as an output signal to the input terminal of the other of said first physiological sensor and said second physiological sensor; and
a signal analyzer configured to receive an electrical signal for analysis from said output terminal of said the other of said first physiological sensor and said second physiological sensor, said electrical signal for analysis comprising a combination of said first electrical signal, said second electrical signal and said pulse sequence signal.

2. The system of synchronization of two physiological measurements of claim 1, wherein said pulse sequence generator is configured to generate a pulse sequence signal having a predetermined initial delay from a start command.

3. The system of synchronization of two physiological measurements of claim 1, wherein said signal analyzer is configured to analyze the synchronism of said first and said second so long as said signal analyzer can resolve at least two pulses of said pulse sequence.

4. The system of synchronization of two physiological measurements of claim 1, wherein said pulse sequence generator configured to generate said pulse sequence at any time that said first electrical signal or said second electrical signal are present.

5. A method of synchronization of two physiological measurements, comprising the steps of:
measuring a first physiological measurement as a function of time from a subject and providing a first electrical signal that encodes data representative of said first physiological measurement;
generating a pulse sequence signal having a predetermined number N equal to or greater than 3 of pulses spaced apart in a predetermined temporal sequence;
combining said first electrical signal and said pulse sequence signal according to the logic represented by Table I for active-low logic or Table II for active-high logic to provide a time base signal;
measuring a second physiological measurement as a function of time from said subject and providing a second electrical signal that encodes data representative of said second physiological measurement;
combining said time base signal with said second electrical signal; and
analyzing said combination of said time base signal and said second electrical signal to determine a result representing a temporal relationship between said first physiological measurement and said second physiological measurement.

6. The method of synchronization of two physiological measurements of claim 5, further comprising the step of:
performing at least one of recording said result, transmitting said result to a data handling system, or to displaying said result to a user.
